(19) United States
(12) Patent Application Publication
(10) Pub. No.: US 2010/0081054 A1
(43) Pub. Date: Apr. 1, 2010

(54) Lithium battery

(75) Inventor: Fenggang Zhao, Dongguan (CN)

Correspondence Address: SALLY CHANG, 7F, NO. 3, ALLEY 32, SEC. 6 CHUNG-HSIAO EAST RD., TAIPEI, TAIWAN, R.O.C. 115, TAIPEI, 115, TW

(73) Assignee: Dongguan Amperex Technology Co., Ltd.

(21) Appl. No.: 12/285,042

(22) Filed: Sep. 29, 2008

(51) Int. Cl. H01M 4/00; H01M 4/58

(52) U.S. Cl. 429/221; 429/231.95; 429/231.8

(57) ABSTRACT

A lithium battery includes anode piece, cathode piece and electrolyte. The anode piece includes anode accumulation structure and anode film attached thereto; the cathode piece includes cathode accumulation structure and cathode film attached thereto; on an identical area surface, reversible capacities of cathode/anode activated materials are in the range of 1.4˜2.4. The lithium battery of the present invention with capacity larger than 5 Ah can achieve preferable safety.

### CROSS REFERENCE OF RELATED APPLICATION

The present invention claiming benefit of patent application entitled “Lithium Battery” filed on May 30, 2008 assigned U.S. application Ser. No. 12/155,146, invented by the same first inventor Fenggang Zhao and owned by the same applicant Dongguan Amperex Technology Co., Ltd, the same representative Tanghua Chen.

### FIELD OF THE INVENTION

The present invention is related to a lithium battery; particularly, to a battery with over 10 ampere-hour (Ah) ratings, even exposed to nake flame, risk of explosion can be effectively reduced.

### BACKGROUND OF THE INVENTION

When charging a lithium battery, lithium ion moves from an anode through an electrolyte to a cathode. Respectively, the anode and cathode are separated into a lithium poor phase and a lithium rich phase respectively. Current gain to compensate changes of the cathode (made of carbon) by an extraneous circuit ensures charge balance in the cathode. Conversely, when discharging, a lithium phosphate (LiFePO₄) based activated material in the anode and an artificial graphite based activated material in the cathode can result in a chemical reaction formula of charging/discharging as follows:

LiFePO₄+6C . . . →Li₁₋ₓFePO₄+LiₓC₆

As above, when X of the subscript of the product Lithium (Liₓ) assigned as an integer 1, product graphite intercalation compounds LiₓC₆ is clearly shown as lithiated graphite (LiC₆), which is an activated material can be further activated promptly upon applications. Safety issues such as thermal stability on lithium battery arises as more and more cathode material of LiC₆ contained. As well known, heat of reaction from cathode mainly results from LiC6 reacted with electrolyte and binder, quantity and property of the binder as well as quantity of the electrolyte are concerned.

Usually, fully charged lithium battery has more than 90% mole ratio carbon material turned into lithiated graphite (LiC₆). Design and implementation of such as electric vehicles (EVs), or uninterrupted power supply (UPS) resort to lithium battery with over 10 Ah ratings. When such a large-capacity battery encounters short-circuit, high temperature or other inappropriate usages, heat accumulated ignited fire or even explosion becomes a potential risk of the battery in use.

Therefore, a brand new lithium battery is sought to solve the problems as above.

### SUMMARY OF THE INVENTION

Accordingly, the present invention is to provide a lithium battery with over 10 ampere hour (Ah) ratings has cathode material of carbon, when the lithium battery is fully charged, cathode material of lithiated graphite (LiC₆) contained relatively lower than ever, thus battery encounters short-circuit, high temperature or other inappropriate usages, heat accumulated ignited fire or even explosion can be largely reduced.

The present invention is to provide the lithium battery comprising an anode piece, a cathode piece, a separator, an electrolyte, and a housing; said cathode piece includes an accumulation structure of copper foil, and activated material, and conductor, and binder; a cathode film attached to the accumulation structure; carbon material adopted as cathode activated material; the anode piece includes an accumulation structure of aluminum foil; and anode activated material, and conductor, and binder; an anode film attached to the accumulation structure.

Either cathode piece or anode piece can be made step by step as following:

Blend said carbon material, said binder, and said conductor with a solution combined to form a cathode paste to spread on the copper foil evenly; when dried, the cathode piece is obtained.

Blend said anode activated material of anode, said conductor, and said binder with a solution combined to form an anode paste to spread on said aluminum foil evenly; when dried, the anode piece is obtained.

With said copper/aluminum foils spread with and weighted by said cathode/anode pastes, a lithium battery is provided with cathode/anode pieces of an identical surface area with a battery capacity balance ratio (m) as reversible capacities of the cathode/anode activated materials shown in a range of 1.4:1˜2.4:1. By which, when the lithium battery is fully charged, to reduce cathode material of fully lithiated graphite (LiC₆) can be expected. Especially, when the battery capacity balance ratio (m) substantially the reversible capacity of the cathode activated material compared to the same of the anode activated material is 2:1. The product graphite intercalation compounds or lithium-intercalated graphite LiₓC₆ basically is shown as LiC12, which leads to even heat accumulated in the battery—when it encounters short-circuit, high temperature or other inappropriate usages—it will not to ignite fire or even explosion as demand.

### BRIEF DESCRIPTION OF THE DRAWINGS

FIG. 1: is a diagrammatic view of lithium battery has a battery capacity balance ratio (m) 1.2:1, through a drift bolt test duration, temperature and voltage changed.

FIG. 2: is a diagrammatic view of lithium battery has a battery capacity balance ratio (m) 1.4:1, through a drift bolt test duration, temperature and voltage changed.

FIG. 3: is a diagrammatic view of lithium battery has a battery capacity balance ratio (m) 1.8:1, 2.0:1, and 2.4:1, through a drift bolt test duration, temperature and voltage changed.

### DETAILED DESCRIPTION OF THE PREFERRED EMBODIMENTS OF THE INVENTION

The description is described according to the appended drawings hereinafter.

A lithium battery comprising an anode piece, a separator, a cathode piece, and a housing. The cathode piece includes a cathode accumulation structure and a graphite (i.e. cathode activated material) based cathode film attached thereto. The anode piece includes an anode accumulation structure and an anode film attached thereto. A polypropylene film equally dimensioned at an opposed breadth of 25 μm adopted as the separator sandwiched in between.

Cathode piece can be formed by steps as following: the cathode piece comprises 85 wt % graphite with a charging capacity per gram 300 mAh/g is used as the cathode activated material, 10 wt % polyvinylidene chloride (PVDF) is used as binder, 5 wt % of Super-p is used as conductor. All the powders as above are mixed with N-methylpyrrolidone to form a cathode paste to spread on a copper foil at a breadth about 12 μm (10⁻⁶ m). A reversible capacity of the cathode piece per square millimeter is defined as (a).

Anode piece can be formed by steps as following: the anode piece comprises 85 wt % lithium phosphate (LiFePO₄) with a charging capacity per gram 127 mAh/g is used as the anode activated material, 10 wt % polyvinylidene chloride (PVDF) is used as binder, 5 wt % of Super-p is used as conductor. All the powders as above are mixed with N-methylpyrrolidone to form an anode paste to spread on an aluminum foil at a breadth about 20 μm (10⁻⁶ m). A reversible capacity of the anode piece per square millimeter is defined as (b).

As above, a ratio of said reversible capacity of the cathode/anode is defined as (a/b) designated as a battery capacity balance ratio (m) in the present invention.

Said anode piece, said separator, and said cathode piece are laminated one by one in order. Being laminated and rolled up said anode piece, separator, and cathode piece to form a core, which is further sealed within said housing filled with electrolyte. The electrolyte containing lithium hexafluorophosphate (LiPF₆) density of concentration 1 mol/L as a lithium salt, and a solvent mixture of ethylene carbonate (EC), ethyl methyl carbonate (EMC), and dimethyl carbonate (DMC) at a ratio of 1:1:1. At least, through an electrolysis process, oxide layers with high densities formed on surfaces of the copper and aluminum foils are available to form a battery.

Accordingly, five sets of lithium batteries with 10 Ah ratings, surface area of each cathode/anode piece spread with cathode/anode activated materials having reversible capacities (a,b) and battery capacity balance ratios (m) as shown in table 1:

| | | | Anode | | Cathode | Reversible | |
|---|---|---|---|---|---|---|---|
| | | | spread | Reversible | spread | capacity | |
| | | | with | capacity | with | of | |
| | Anode | Cathode | anode | of anode: | cathode | cathode: | |
| | activated | activated | paste | (a) | paste | (b) | |
| No. | material | material | (mg/cm²) | (mAh/g) | (mg/cm²) | (mAh/g) | (a/b): m |
| 1 | LiFePO₄ | Graphite | 28.504 | 3.077 | 14.673 | 3.742 | 1.2 |
| 2 | LiFePO₄ | Graphite | 28.504 | 3.077 | 17.140 | 4.371 | 1.4 |
| 3 | LiFePO₄ | Graphite | 28.504 | 3.077 | 22.074 | 5.629 | 1.8 |
| 4 | LiFePO₄ | Graphite | 28.504 | 3.077 | 24.477 | 6.242 | 2.0 |
| 5 | LiFePO₄ | Graphite | 28.504 | 3.077 | 26.944 | 6.871 | 2.4 |

Drift bolt tests:

Said five sets of lithium batteries charged up by a constant current of 10 ampere (A), 0.5 coulomb (C) to 3.65 voltage (V). Then said five sets of lithium batteries are charged under constant 3.65 V, till the current reduced to 0.05 C/1 A then stop charging.

Said five sets of lithium batteries are arranged for drift bolt tests under conditions such as the batteries fixed to a bolting machine to drift a bolt of 2.5 mm length at a speed of 40 mm/s along maximum surfaces of said batteries to pierce through the core 20 mm.

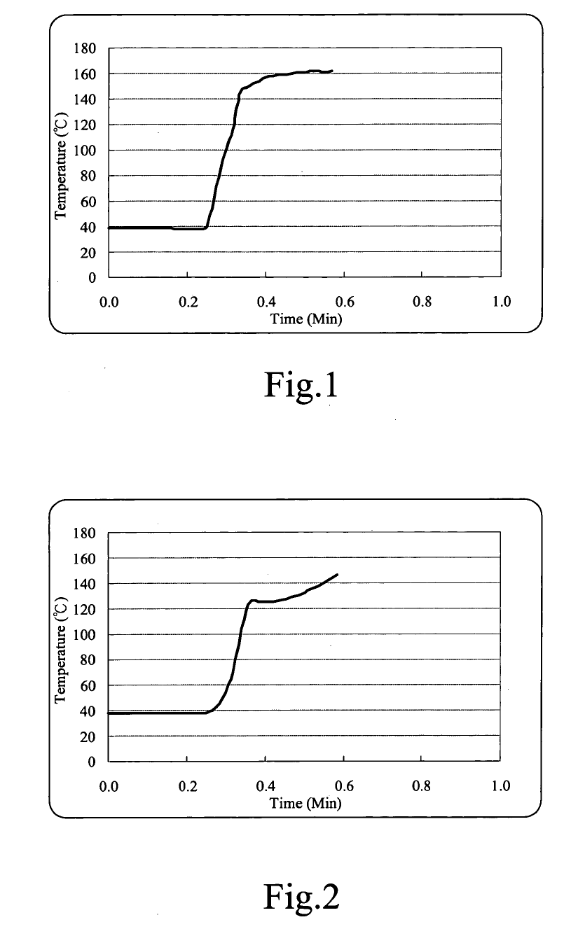

FIG. 1 shows a first set of lithium batteries (conventional lithium batteries with a battery capacity balance ratio (m) 1.2) through a drift bolt test duration, temperature and voltage changed. Through bolting process, temperature and voltage are changed through test duration. As a result, after the bolt pierced into the batteries about 15 seconds, voltages of the batteries are lowered from 3.7 V to 0 V. A temperature on a surface of the battery is increased up to, at least, 160 ° C., fumes and smokes burst out from the batteries.

FIG. 2 shows a second set of lithium batteries (with a battery capacity balance ratio (m) 1.4) through a drift bolt test duration, temperature and voltage changed. As a result, after the bolt pierced into the batteries about 15 seconds, voltages of the batteries are lowered from 3.7 V to 0 V. A temperature on a surface of the battery is increased up to 140° C., but no fumes or smokes bursts out.

As to a third, fourth, and fifth sets of batteries, after the bolt pierced into the batteries, which are not shown as short-circuit, surface temperatures of the batteries are constant at 40° C., no fumes or smokes bursts out.

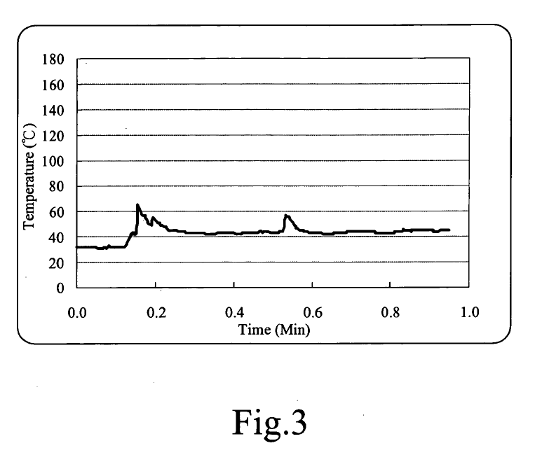

FIG. 3 shows the third, fourth, and fifth sets of lithium batteries through a drift bolt test duration, temperature and voltage changed.

Anode activated materials of the lithium battery of the present invention can be selected from the following but not restricted to them: lithium cobalt oxide (LiCoO2), lithium manganese oxide (LiMnO4), lithium iron phosphate (LiFePo4), and lithium-nickel-cobalt-manganese oxide (LiNiCoMnO2) can release lithium ions as activated materials. Cathode activated materials selected from one or more of the following carbon materials: natural graphite, artificial graphite (such as Meso-carbon micrbeads, needle coke graphite), carbon filaments, and hard carbon can absorb or release lithium ions. Therefore, when charging, lithium ions moves from the anode to the cathode, and graphite intercalation compounds or lithium-intercalated graphite LiₓC₆ is formed on the cathode. Through drift bolt test, battery capacity balance ratio (m) is in the range of 1.4<m<2.4. Due to the lithiated graphite (LiC₆) contained in the cathode is relatively lower than ever, the lithium battery of the present invention is more safe than others. In consideration of the battery capacity affected by (m) ratio, so the (m) ratio is limited within 1.4˜2.4.

EVs now resort to sets of lithium batteries, those each lithium battery of larger capacity can be used safely.

What is claim claimed:

1. A lithium battery comprising an anode piece, a separator, and a cathode piece; the cathode piece includes a cathode accumulation structure and a cathode film attached thereto; a surface area of the cathode film spread with a cathode activated material with a reversible capacity of (a) mA; the anode piece includes an anode accumulation structure with an anode activated material with a reversible capacity of (b) mA; the separator sandwiched between the cathode and anode pieces, when charging, lithium ions move from the anode through electrolyte to the cathode, lithiated graphite (LiC₆) formed on the cathode characterized in that: a ratio of a and b is in the range of 1.4<a/b<2.4.

2. The lithium battery of claim 1 wherein the anode activated material is selected from one of the following: lithium cobalt oxide (LiCoO2), lithium manganese oxide (LiMnO4), lithium iron phosphate (LiFePo4), and lithium-nickel-cobalt-manganese oxide (LiNiCoMnO2).

3. The lithium battery of claim 1 wherein the cathode activated material is selected from one or more from the following: natural graphite, artificial graphite (such as Meso-carbon micrbeads, needle coke graphite), carbon filaments, and hard carbon.

4. The lithium battery of claim 1 wherein the cathode activated material is graphite, the anode activated material is lithium iron phosphate (LiFePo4).

5. The lithium battery of claims 1-4 wherein capacity of the lithium battery larger than 5 Ah.

6. The lithium battery of claims 1-4 wherein a/b ratio is in the range of 1.6˜2.4, capacity of the battery not less than 5 Ah.

7. The lithium battery of claim 6 wherein a/b ratio is in the range of 1.8˜2.
